(19) United States
(12) Patent Application Publication
(10) Pub. No.: US 2010/0055246 A1
(43) Pub. Date: Mar. 4, 2010

(54) NUTRITION DELIVERY CAPSULES FOR FUNCTIONAL FOODS

(76) Inventor: Dong June Ahn, Seoul (KR)

Correspondence Address: EDWARDS ANGELL PALMER & DODGE LLP, P.O. BOX 55874, BOSTON, MA, 02205, US

(21) Appl. No.: 12/200,789

(22) Filed: Aug. 28, 2008

(51) Int. Cl. A23L 1/305; A23L 1/302; A23L 1/304

(52) U.S. Cl. 426/72

(57) ABSTRACT

Stabilized nanoparticulate nutritive compositions include nano-scale particles of at least one nutritive substance and molecules of at least one stabilizing agent that associate with the nutritive nanoparticles. Stabilized nanoparticulate nutritive compositions are prepared by suspending relatively larger particles of a nutritive substance in a solvent and breaking down the larger sized nutritive particles and associating the particles with the stabilizing agent. Stabilized nanoparticulate nutritive compositions can readily be combined with a variety of food media.

### BACKGROUND

A. Nutritive Substances

A nutrient is a food or a chemical that an organism needs to live and grow or a substance used in an organism's metabolism that must be taken in from its environment. Humans and other animals typically acquire nutrients by the ingestion of foods. Organic nutrients include carbohydrates, fats, fatty acids, essential fatty acids, proteins, amino acids, essential amino acids, and vitamins. Inorganic chemical compounds such as minerals and water are also considered nutrients.

A nutrient is essential to an organism if it cannot be synthesized by the organism in sufficient quantities and must be obtained from an external source. Nutrients needed in relatively large quantities are called macronutrients and those needed in relatively small quantities are called micronutrients.

Macronutrients include carbohydrates, fats, fiber, proteins and water. The macronutrients (excluding fiber and water) provide energy, which is measured in kilocalories. Carbohydrates and proteins provide approximately four calories of energy per gram, while fats provide approximately nine calories per gram.

Micronutrients (e.g., vitamins and minerals) do not provide energy, but they are nonetheless needed for proper health. For example, many vitamins (e.g., B complex vitamins) function as precursors for enzyme cofactor bio-molecules (coenzymes) that help act as catalysts and substrates in metabolism.

Substances generally accepted to be vitamins in the human diet include, but are not limited to, vitamin A, vitamin B₁, vitamin B₂, Vitamin B₃, vitamin B₅, vitamin B₆, vitamin B₇, vitamin B₉, vitamin B₁₂, vitamin C, vitamin D, vitamin E, and vitamin K.

Dietary minerals include, but are not limited to, iron, calcium, cobalt, chromium, copper, iodine, manganese, selenium, zinc, and molybdenum. Dietary minerals are generally needed by the human body in small quantities, generally less than 100 mg/day.

The intake of nutrients in proper amounts is linked to nutrition and overall health. Poor diet can have an injurious impact on health, causing deficiency diseases such as but not limited to scurvy or beriberi; health-threatening conditions like obesity and metabolic syndrome, and such common chronic systemic diseases as cardiovascular disease, diabetes, and osteoporosis.

### BRIEF SUMMARY

The illustrated embodiments relate to novel stabilized nanoparticulate nutritive compositions and methods for manufacturing and using the same. The stabilized nanoparticulate nutritive compositions include nano-particles of at least one nutritive substance and a stabilizing agent associated with the nano-scale particles. The stabilizing agent stabilizes the nano-particles by, for example, helping to overcome inter-particle attractive forces that would tend to cause the nano-particles to agglomerate into larger particles.

In one embodiment, a stabilized, nanoparticulate nutritive composition is described. In one embodiment, the stabilized nanoparticulate nutritive composition includes nano-scale particles of at least one nutritive substance and molecules of at least one stabilizing agent associated with the nano-scale particles.

In one embodiment, the particles of the at least one nutritive substance have a size in a range from about 1 nm to about 2000 nm. In another embodiment, the particles of the at least one nutritive substance have a size in a range from about 50 nm to about 1500 nm. In yet another embodiment, the particles of the at least one nutritive substance have a size in a range from about 100 nm to about 1000 nm.

Suitable examples of nutritive substances include, but are not limited to, carbohydrates, proteins, fats, essential fatty acids, amino acids, essential amino acids, minerals, water-partitionable vitamin compounds, or lipid-partitionable vitamin compounds, and combinations thereof.

Suitable examples of stabilizing agents that can associate with the nanoparticles include at least one of, but are not limited to, an organic acid, an amino acid, a long-chain amine, a surfactant, an anionic surface stabilizer, a cationic surface stabilizer, a zwitterionic surface stabilizer, or an ionic surface stabilizer, and optionally includes one or more long-chain alcohols.

In one embodiment, the stabilizing agent molecules can be crosslinked. For example, amino acids can be crosslinked to at least partially or completely form a peptide or proteinaceous shell around the nutritive nanoparticle.

In one embodiment, the nano-scale particles of the nanoparticulate nutritive composition are substantially stable in water-based and food-based media. This is the case at least in part because of the presence of the surface stabilizing agent molecules associated with and/or bonded to the nano-scale particles

In one embodiment, a method for preparing a stabilized, nanoparticulate nutritive composition is disclosed. The method includes providing a precursor mixture that includes at least one nutritive substance, at least one solvent in which the at least one nutritive substance has a solubility of less than 10 mg/ml, and at least one stabilizing agent; and treating the precursor mixture to produce nano-scale particles of the at least one nutritive substance.

In one embodiment, the nano-scale particles are mixed with the solvent and the stabilizing agent in the treating process. As such, the nano-scale particles are stabilized by having an at least partial coating of the stabilizing agent. The treating process breaks down the particles of the nutritive substance in the precursor mix to particles having a size in a range from about 1 nm to about 2000 nm.

Suitable solvents for carrying out the method include, but are not limited to, water, aqueous salt solutions, methanol, ethanol, propanol, butanol, glycerol, propylene glycol, propylene glycol ethers, dimethyl formamide, N-methyl pyrrolidone, acetone, diethyl ether, chloroform, benzene, tetrahydrofuran, hexanes, ethyl acetate, methyl methacrylate, toluene, phenyl ethers, vegetable oil, and combinations thereof.

In one embodiment, the treating step of the method described above further includes transferring the precursor mixture to a microfluidizer having an interaction chamber capable of producing shear, impact, cavitation, and attrition forces; and subjecting the precursor mixture to said forces at a temperature not exceeding 40° C. and a fluid pressure of from about 3,000 to about 30,000 psi by passing the precursor mixture through said interaction chamber to obtain nutritive particles having an effective average particle size in a range from about 1 nm to about 2000 nm. One will appreciate, however, that it may take multiple passes through the microfluidizer in order to obtain nutritive particles having the desired size.

In another embodiment, the treating step of the method described above further includes sonicating the precursor mixture in a temperature not exceeding 40° C., for a time in a range from about 5 minutes to about 2 hours, wherein the sonicating suspends the particles of the nutritive compound in the solvent, allows the stabilizing agent to associate with the particles of the nutritive compound, and disrupts or breaks down the particles of the nutritive compound into smaller nutritive particles having a size in a desired size range.

In one embodiment, the method further includes adding at least one crosslinking agent so as to crosslink the stabilizing agent. The crosslinking agent can be added before, during, or after the microfluidization or sonication treatment.

In one embodiment, the method further includes separating the stabilized nutritive particles from the solvent. Suitable techniques for separating the nanoparticles of the nutritive substances from the solvent include, but are not limited to, centrifugation, filtration, and spray drying. One will of course appreciate that the nutritive particles do not significantly agglomerate even after the solvent is removed because of the action of the stabilizing agent.

In one embodiment, a fortified food composition that contains nanoparticles of a stabilized, nanoparticulate nutritive composition is disclosed. The fortified food composition includes a food medium and nanoparticles of a stabilized, nanoparticulate nutritive composition included in the food medium. The nanoparticles of a stabilized, nanoparticulate nutritive composition include nano-scale particles of at least one nutritive substance and molecules of at least one stabilizing agent coupled to the nano-scale particles. In one embodiment, the nano-scale particles have a size in a range from about 1 nm to about 2000 nm.

In one embodiment, the fortified food composition includes about 0.001 wt % to about 50 wt % of the stabilized nutritive particles. In another embodiment, the fortified food composition includes about 0.01 wt % to about 40 wt % of the stabilized nutritive particles. In yet another embodiment, the fortified food composition includes about 0.1 wt % to about 30 wt % of the stabilized nutritive particles.

The stabilized nutritive particles can be incorporated into a number of foods. Suitable examples of foods include, but are not limited to, pet foods, water-based beverages, processed meat products, processed fish products, gels such as energy gels, jams, pastes, nutrition bars, bakery products, creams, sauces, dairy products, confections, or syrups, and combinations thereof.

These and other objects and features of stabilized nanoparticulate nutritive compositions will become more fully apparent from the following description and appended claims, or may be learned by the practice of the claims as set forth hereinafter.

The foregoing summary is illustrative only and is not intended to be in any way limiting. In addition to the illustrative aspects, embodiments, and features described above, further aspects, embodiments, and features will become apparent by reference to the following detailed description.

### DETAILED DESCRIPTION

The illustrative embodiments described in the detailed description and claims are not meant to be limiting. Other embodiments may be utilized, and other changes may be made, without departing from the spirit or scope of the subject matter presented here.

### I. Introduction

The illustrated embodiments relate to novel stabilized nanoparticulate nutritive compositions and methods for manufacturing the same. The stabilized nanoparticulate nutritive compositions include nano-particles of at least one nutritive substance and a stabilizing agent associated with the nano-scale particles. The stabilizing agent stabilizes the nano-particles by, for example, helping to overcome inter-particle attractive forces that would tend to cause the nano-particles to agglomerate into larger particles.

The illustrated embodiments are based partly on the discovery that nutritive particles having a small effective particle size can be prepared by breaking down larger particles of the nutritive substance in conjunction with a surface stabilizing agent in a in solvent in which the nutritive particles are not readily soluble. Such particles exhibit unexpectedly high bioavailability and they can be incorporated into a variety of food compositions. Their greater bioavailability means, for example, that nanoparticulate nutritive compositions can be given in smaller doses with less of the nutritive substance passing through the body unabsorbed. In addition, because of their exceptionally small size, the nutritive nanoparticles exhibit significantly improved mouth feel when they are incorporated into food compositions.

As used herein, the term “nutritive particles” refers to solid, crystalline phase particles or a micellular phase of various nutritive compounds, such as but not limited to vitamin B₁₂, a protein, or a fat.

As used herein, the term “precursor mixture” refers to a mixture of compounds used to make a stabilized nanoparticulate nutritive composition. In a minimal sense, the precursor mixture includes nutritive particles, at least one solvent, and at least on stabilizing agent. The nutritive particles may be provided as a powder or a slurry.

As used herein, the term “stable” or “stably suspended” when used in the context of a stabilized nanoparticulate nutritive composition refers to a system in which particles of between 1 nm and 2000 nm are suspended or dispersed in a continuous phase of a different composition (i.e., a solvent) such that the stabilized nanoparticles do not appreciably fall out of suspension and/or agglomerate over a relatively long period of time (e.g., weeks or months).

As used herein, the “stabilizing agent” refers to a compound or mixture of compounds that are compatible with a given solvent and that associate with the surface of nutritive particles to prevent coagulation or agglomeration of the particles in stable suspension, for example, by overcoming the attraction caused by inter-particle forces.

As used herein, the term “nano-scale” or “nano-sized” means a size between 1 nm and 2000 nm.

### II. Components Used to Manufacture Stabilized, Nanoparticulate Nutritive Compositions

The following components can be used to carry out methods for manufacturing stable nanoparticulate vitamin compositions of vitamin particles according to the illustrated embodiments.

### A. Nutrients

The nutrient substances used to prepare the stabilized, nanoparticulate nutritive compositions according to the illustrated embodiments are provided as powders and/agglomerates of particles, solvent-based slurries of individual particles and/or agglomerates, liquids, or non-particulate solids. Examples of suitable nutrient substances that can be used in the illustrated embodiments include, but are not limited to, at least one of a carbohydrate, a protein, a fat, an essential fatty acid, an amino acid, an essential amino acid, a mineral, a water-partitionable vitamin compound, or a lipid-partitionable vitamin compound, and combinations thereof.

In a broad range, the nutrient particles in the stabilized, nanoparticulate nutritive composition have a size in a range from about 1 nm to about 2000 nm. In a narrower range, the nutrient particles in the stabilized, nanoparticulate nutritive composition have a size in a range from about 50 nm to about 1500 nm. In a still narrower range, the nutrient particles in the stabilized, nanoparticulate nutritive composition have a size in a range from about 100 nm to about 1000 nm. In some embodiments, the nutrient particles have a size in a range from about 1 nm, 5 nm, 10 nm, 50 nm, 100 nm, 250 nm, 500 nm, 750 nm, 1000 nm, or 1500 nm, to about 5 nm, 10 nm, 50 nm, 100 nm, 250 nm, 500 nm, 750 nm, 1000 nm, 1500 nm, or 2000 nm. In some embodiments, the vitamin particles have a size of about 1 nm, 5 nm, 10 nm, 50 nm, 100 nm, 250 m, 500 nm, 750 nm, 1000 nm, 1500 nm, or 2000 nm.

Carbohydrates are simple organic compounds that are aldehydes or ketones with many hydroxyl groups added, usually one on each carbon atom that is not part of the aldehyde or ketone functional group. Carbohydrates include simple sugars such as glucose and fructose, which are referred to as monosaccharides, and complex carbohydrates such as but not limited to dextrins, starches, glycogen, cellulose, and chitin, which are referred to as polysaccharides. Carbohydrates fill numerous roles in living things, such as but not limited to the storage and transport of energy (starch, glycogen) and structural components (cellulose in plants, chitin in animals). Additionally, carbohydrates and their derivatives play major roles in the function of the immune system, fertilization, pathogenesis, blood clotting, and development.

Proteins are large organic compounds made of amino acids arranged in a linear chain and joined together by peptide bonds between the carboxyl and amino groups of adjacent amino acid residues. Proteins are essential parts of organisms and participate in many processes within cells. Many proteins are enzymes that catalyze biochemical reactions and are vital to metabolism. Proteins also have structural or mechanical functions, such as but not limited to actin and myosin in muscle and the proteins in the cytoskeleton, which form a system of scaffolding that maintains cell shape. Other proteins are important in cell signaling, immune responses, cell adhesion, and the cell cycle. Proteins are also necessary in the diet, since animals cannot synthesize all the amino acids they need and must obtain essential amino acids from food. Through the process of digestion, animals break down ingested protein into free amino acids that are then used in metabolism.

Amino acids are the building block for proteins. An amino acid is a molecule containing both amine and carboxyl functional groups. Amino acids include, but are not limited to, alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, and valine.

Of the amino acids, eight are generally regarded as essential for humans: phenylalanine, valine, threonine, tryptophan, isoleucine, methionine, leucine, and lysine. Cysteine (or sulphur-containing amino acids), tyrosine (or aromatic amino acids), histidine and arginine are additionally required by infants and growing children. Essential amino acids are so called not because they are more important to life than the others, but because the body does not synthesize them, making it essential to include them in one's diet in order to obtain them. In addition, the amino acids arginine, cysteine, glycine, glutamine, histidine, proline, serine and tyrosine are considered conditionally essential, meaning they are not normally required in the diet, but must be supplied exogenously to specific populations that do not synthesize it in adequate amounts.

Dietary minerals include, but are not limited to, calcium, chloride, copper, fluorine, iodine, iron, magnesium, phosphorus, potassium, selenium, sodium, zinc, boron, chromium, cobalt, molybdenum, nickel, and sulfur. Dietary minerals are generally needed by the human body in small quantities, generally less than 100 mg/day. Dietary minerals are needed for many biological function in the body including, but not limited to, bone development, blood cell development, redox enzymes, oxygen transport, and muscle contraction.

Vitamins are classified as either water-partitionable, meaning that they dissolve easily in water, or lipid-partitionable, which are typically soluble in most common organic solvents and are absorbed through the intestinal tract with the help of lipids. In general, water-partitionable vitamins are readily excreted from the body, while lipid-partitionable vitamins are retained for a longer period of time. Water-partitionable vitamins include but are not limited to the B vitamins (i.e., vitamins B₁, B₂, B₃, B₅, B₆, B₇, B₉, and B₁₂) and vitamin C. Lipid-partitionable vitamins include but are not limited to vitamins A, D, E and K.

### B. Solvents

The solvents used to prepare the stabilized, nanoparticulate nutritive compositions provide a continuous phase for dispersing nutritive particles of the precursor mixture and/or dispersing the nutritive particles of a stabilized nanoparticulate nutritive composition. The solvent serves as a carrier for the nutritive particles and the stabilizing agent. Various solvents or mixtures of solvents can be used, including but not limited to water and organic solvents.

The nutritive substance is typically poorly soluble and dispersible in at least one liquid solvent. By “poorly soluble” it is meant that the nutritive substance has a solubility in the liquid dispersion medium, e.g., water, of less than about 10 mg/ml, or less than about 1 mg/ml.

The choice of solvent is at least partly a function of nutritive substance or substances. Most nutritive substances can either be classified as water-partitionable or lipid-partitionable, while many minerals are not particularly soluble in either water-based or lipid-based media. Vitamins, for example, are typically classified as either water-partitionable, meaning that they dissolve easily in water, or lipid-partitionable, meaning that they dissolve easily in most common organic solvents and are absorbed through the intestinal tract with the help of lipids. Water-partitionable vitamins include but are not limited to the B-complex vitamins (i.e., vitamins B₁, B₂, B₃, B₅, B₆, B₇, B₉, and B₁₂) and vitamin C. Lipid-partitionable vitamins include but are not limited to vitamins A, D, E and K.

Suitable examples of solvents in which water-partitionable nutritive compounds have a solubility of less than 10 mg/ml include, but are not limited to, acetone, diethyl ether, chloroform, benzene, tetrahydrofuran, hexanes, ethyl acetate, methyl methacrylate, toluene, phenyl ethers, vegetable oils (e.g., safflower oil or rape seed oil), and combinations thereof.

Suitable examples of solvents in which lipid-partitionable nutritive compounds have a solubility of less than 10 mg/ml include, but are not limited to, water, aqueous salt solutions, methanol, ethanol, propanol, butanol, glycerol, propylene glycol, or propylene glycol ethers, and combinations thereof.

### C. Stabilizing Agents

The stabilizing agents used to prepare the stabilized, nanoparticulate nutritive compositions associate with the surface of nutritive particles to prevent coagulation or agglomeration of the particles by, for example, overcoming the tendency of nutritive particles to agglomerate due to inter-particle attraction. A stabilizing agent or a mixture of agents is chosen such that it is dispersible or otherwise compatible with a given solvent used to form the stabilized, nanoparticulate nutritive compositions. For example, the agent or agents can be weakly solublized by the solvent so that the stabilizing agent is free to associate with the nutritive particles, but the solvent does not tend to wash the molecules of stabilizing agent off of the nutritive particles.

Stabilizing agent molecules are complexed with the nutritive particles to control formation of the stabilized, nanoparticulate nutritive compositions. The stabilizing agent is selected to promote the formation of nanoparticulate nutritive particles that have a desired stability, size, and/or uniformity. Examples of suitable stabilizing agents include, but are not limited to, a variety organic molecules, polymers, and oligomers. The stabilizing agent can interact and associate with the nutritive particles dissolved or dispersed within an appropriate solvent or carrier through various mechanisms, including but not limited to ionic bonding, covalent bonding, lone pair electron bonding, or hydrogen bonding. In one embodiment, useful stabilizing agents are believed to include those which physically adhere to the surface of the nutritive particle but do not chemically bond to the nutritive.

Suitable stabilizing agents can be selected from known organic and inorganic pharmaceutical excipients. Such excipients include but are not limited to various polymers, low molecular weight oligomers, natural products and surfactants. Stabilizing agents include but are not limited to nonionic and anionic surfactants. Representative examples of excipients include but are not limited to gelatin, casein, lecithin (phosphatides), gum acacia, cholesterol, tragacanth, stearic acid, benzalkonium chloride, calcium stearate, glyceryl monostearate, cetostearyl alcohol, cetomacrogol emulsifying wax, sorbitan esters, polyoxyethylene alkyl ethers, e.g., macrogol ethers such as cetomacrogol 1000, polyoxyethylene castor oil derivatives, polyoxyethylene sorbitan fatty acid esters, e.g., the commercially available Tweens, polyethylene glycols, polyoxyethylene stearates, colloidol silicon dioxide, phosphates, sodium dodecylsulfate, carboxymethylcellulose calcium, carboxymethylcellulose sodium, methylcellulose, hyclroxyethylcellulose, hydroxypropylcellulose, hydroxypropylmethycellulose phthalate, noncrystalline cellulose, magnesium aluminum silicate, triethanolamine, polyvinyl alcohol (PVA), and polyvinylpyrrolidone (PVP). Most of these excipients are described in detail in the Handbook of Pharmaceutical Excipients, published jointly by the American Pharmaceutical Association and The Pharmaceutical Society of Great Britain, the Pharmaceutical Press, 1986. The stabilizing agents are commercially available and/or can be prepared by techniques known in the art. Two or more stabilizing agents can be used in combination.

Other examples of suitable stabilizing agents include, but are not limited to, organic acids, long-chain amines, and surfactants. In addition to an organic acid, a long-chain amine, and/or a surfactant, the stabilizing agent may optionally include at least one long-chain alcohol.

Examples of suitable organic acids include so-called fatty acids. A fatty acid is an organic compound with a carboxylic acid head group and an aliphatic tail. The tail may be either saturated or unsaturated. A saturated fatty acid has no double bonds in its tail (i.e., the tail is fully saturated with hydrogen). An unsaturated fatty acid has at least one double bond in its tail (i.e., the tail is not fully saturated with hydrogen).

Examples of suitable saturated fatty acids include, but are not limited to, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, uncosanoic acid, docosanoic acid, tricosanoic acid, and tetracosanoic acid. This series of fatty acids have tail lengths that range from four carbons to 24 carbons. In some embodiments, metal salts of the fatty acids may be used in lieu of or in addition to the carboxylic acid form.

Examples of suitable unsaturated fatty acids include, but are not limited to, undecylenic acid, myristoleic acid, palmitoleic acid, oleic acid, linoleic acid, alpha-linolenic acid, arachidonic acid, eicosapentaenoic acid, erucic acid, and docosahexaenoic acid. This series of fatty acids have tail lengths that range from 11 carbons to 24 carbons. In some embodiments, metal salts of the fatty acids may be used in lieu of or in addition to the carboxylic acid form.

Examples of suitable long-chain amines include, but are not limited to, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, eicosylamine, uncosylamine acid, docosylamine acid, tricosylamine acid, tetracosylamine, decenylamine, undecenylamine, dodecenylamine, tridecenylamine, tetradecenylamine, pentadecenylamine, hexadecenylamine, heptadecenylamine, octadecenylamine, nonadecenylamine, eicocenylamine, uncocenylamine, dococenylamine, tricocenylamine, and tetracocenylamine.

Examples of suitable surfactants include, but are not limited to, octylphenol ethoxylates, phosphonic acids, phosphinic acids, sulfonic acids, and polyethylene glycol monoalkyl ethers. Example octylphenol ethoxylates include detergents of the well-known Triton-X series. Examples of Triton-X detergents include Triton-X 15, Triton-X 35, Triton-X 45, Triton-X 100, Triton-X 102, Triton-X 114, Triton-X 165, Triton-X 305, Triton-X 405, and Triton-X 705. Polyethylene glycol monoalkyl ethers have the general formula CH₃(CH₂)_{y}O(CH₂CH₂O)ₓH. Example polyethylene glycol monoalkyl ethers include tetraethylene glycol monooctyl ether, pentaethylene glycol monooctyl ether, hexaethylene glycol monooctyl ether, pentaethylene glycol monodecyl ether, pentaethylene glycol monodecyl ether, nonaethylene glycol monodecyl ether, octaethylene glycol monododecyl ether, nonaethylene glycol monododecyl ether, decaethylene glycol monododecyl ether, octaethylene glycol monotridecyl ether, and dodecyl glycol monodecyl ether.

Examples of suitable long-chain alcohols are organic compounds with at least one hydroxyl functional group attached to an aliphatic tail. The aliphatic tail may be unbranched or branched and the aliphatic tail may be saturated or unsaturated. Example long-chain alcohols include, but are not limited to, butanol, isobutanol, pentanol, hexanol, heptanol, octanol, nonanol, decanol, undecanol, dodecanol, tetradecanol, cetyl alcohol, stearyl alcohol, arachidyl alcohol, docosanol, octanosol, ethyl hexanol, palmitoleyl alcohol, stearyl alcohol, isostearyl alcohol, elaidyl alcohol, oleyl alcohol, linoleyl alcohol, elaidolinoleyl alcohol, linolenyl alcohol, elaidolinolenyl alcohol, ricinoleyl alcohol, arachidyl alcohol, behenyl alcohol, erucyl alcohol, lignoceryl alcohol, ceryl alcohol, montanyl alcohol, myricyl alcohol, lacceryl alcohol, geddy1 alcohol, 1-hexadecanol, 1-octadecanol, 1-eicosanol, 1-docosanol, 1-tetracosanol, 1-hexacosanol, 1-octacosanol, 1-triacontanol, 1-dotriacontanol, and 1-tetratriacontanol.

Additional examples of suitable stabilizing agents include, but are not limited to, cetyl pyridinium chloride, gelatin, casein, phosphatides, dextran, glycerol, gum acacia, cholesterol, tragacanth, stearic acid, benzalkonium chloride, calcium stearate, glycerol monostearate, cetostearyl alcohol, cetomacrogol emulsifying wax, sorbitan esters, polyoxyethylene alkyl ethers, polyoxyethylene castor oils, polyoxyethylene sorbitan fatty acid esters, polyethylene glycols, dodecyl trimethyl ammonium bromide, polyoxyethylene stearates, colloidal silicon dioxide, phosphates, sodium dodecylsulfate, carboxymethylcellulose calcium, hydroxypropyl celluloses, hydroxypropyl methylcellulose, carboxymethylcellulose sodium, methylcellulose, hydroxyethylcellulose, hydroxypropylmethyl-cellulose phthalate, noncrystalline cellulose, magnesium aluminum silicate, triethanolamine, polyvinyl alcohol, polyvinylpyrrolidone, 4-(1,1,3,3-tetramethylbutyl)-phenol polymer with ethylene oxide and formaldehyde, poloxamers; poloxamines, a charged phospholipid, dioctylsulfosuccinate, dialkylesters of sodium sulfosuccinic acid, sodium lauryl sulfate, alkyl aryl polyether sulfonates, mixtures of sucrose stearate and sucrose distearate, p-isononylphenoxypoly-(glycidol), decanoyl-N-methylglucamide; n-decyl β-D-glucopyranoside; n-decyl β-D-maltopyranoside; n-dodecyl β-D-glucopyranoside; n-dodecyl β-D-maltoside; heptanoyl-N-methylglucamide; n-heptyl-β-D-glucopyranoside; n-heptyl β-D-thioglucoside; n-hexyl β-D-glucopyranoside; nonanoyl-N-methylglucamide; n-noyl β-D-glucopyranoside; octanoyl-N-methylglucamide; n-octyl-β-D-glucopyranoside; octyl β-D-thioglucopyranoside; lysozyme, PEG-derivatized phospholipid, PEG-derivatized cholesterols, PEG-derivatized vitamin A, PEG-derivatized vitamin E, random copolymers of vinyl acetate and vinyl pyrrolidone, a polymer, a biopolymer, a polysaccharide, a cellulosic, an alginate, a nonpolymeric compound, a phospholipid, zwitterionic stabilizers, poly-n-methylpyridinium, anthryul pyridinium chloride, chitosan, polylysine, polyvinylimidazole, polybrene, polymethylmethacrylate trimethylammoniumbromide bromide (PMMTMABr), hexyldesyltrimethylammonium bromide (HDMAB), polyvinylpyrrolidone-2-dimlethylaminoethyl methacrylate dimethyl sulfate, 1,2 Dipalmitoyl-sn-Glycero-3-Phosphoethanolamine-N-[Amino(Polyethylene Glycol)2000] (sodium salt), Poly(2-methacryloxyethyl trimethylammonium bromide), poloxamines, lysozyme, alginic acid, carrageenan, POLYOX, cationic lipids, sulfonium, phosphonium, quarternary ammonium compounds, stearyltrimethylammonium chloride, benzyl-di(2-chloroethyl)ethylammonium bromide, coconut trimethyl ammonium chloride, coconut trimethyl ammonium bromide, coconut methyl dihydroxyethyl ammonium chloride, coconut methyl dihydroxyethyl ammonium bromide, decyl triethyl ammonium chloride, decyl dimethyl hydroxyethyl ammonium chloride, decyl dimethyl hydroxyethyl ammonium bromide, C₁₂₋₁₅dimethyl hydroxyethyl ammonium chloride, C₁₂₋₁₅dimethyl hydroxyethyl ammonium bromide, coconut dimethyl hydroxyethyl ammonium chloride, coconut dimethyl hydroxyethyl ammonium bromide, myristyl trimethyl ammonium methyl sulphate, lauryl dimethyl benzyl ammonium chloride, lauryl dimethyl benzyl ammonium bromide, lauryl dimethyl(ethenoxy)₄ ammonium chloride, lauryl dimethyl(ethenoxy)₄ ammonium bromide, N-alkyl(C₁₂₋₁₈)dimethylbenzyl ammonium chloride, N-alkyl(C₁₄₋₁₈)dimethyl-benzyl ammonium chloride, N-tetradecyldimethylbenzyl ammonium chloride monohydrate, dimethyl didecyl ammonium chloride, N-alkyl and (C₁₂₋₁₄)dimethyl 1-napthylmethyl ammonium chloride, trimethylammonium halide, alkyl-trimethylammonium salts, dialkyl-dimethylammonium salts, lauryl trimethyl ammonium chloride, ethoxylated alkyamidoalkyldialkylammonium salt, an ethoxylated trialkyl ammonium salt, dialkylbenzene dialkylammonium chloride, N-didecyldimethyl ammonium chloride, N-tetradecyldimethylbenzyl ammonium, chloride monohydrate, N-alkyl(C₁₂₋₁₄)dimethyl 1-naphthylmethyl ammonium chloride, dodecyldimethylbenzyl ammonium chloride, dialkyl benzenealkyl ammonium chloride, lauryl trimethyl ammonium chloride, alkylbenzyl methyl ammonium chloride, alkyl benzyl dimethyl ammonium bromide, C₁₂, C₁₅, C₁₇ trimethyl ammonium bromides, dodecylbenzyl triethyl ammonium chloride, poly-diallyldimethylammonium chloride, dimethyl ammonium chlorides, alkyldimethylammonium halogenides, tricetyl methyl ammonium chloride, decyltrimethylammonium bromide, dodecyltriethylammonium bromide, tetradecyltrimethylammonium bromide, methyl trioctylammonium chloride, polyquaternium 10, tetrabutylammonium bromide, benzyl trimethylammonium bromide, choline esters, benzalkonium chloride, stearalkonium chloride compounds, cetyl pyridinium bromide, cetyl pyridinium chloride, halide salts of quaternized polyoxyethylalkylamines, quaternized ammonium salt polymers, alkyl pyridinium salts, amines, protonated quaternary acrylamides, methylated quaternary polymers, cationic guar, benzalkonium chloride, a carbonium compound, a phosphonium compound, an oxonium compound, a halonium compound, a cationic organometallic compound, a quarternary phosphorous compound, a pyridinium compound, an anilinium compound, an ammonium compound, a hydroxylammonium compound, a primary ammonium compound, a secondary ammonium compound, a tertiary ammonium compound, behenalkonium chloride, benzethonium chloride, cetylpyridinium chloride, behentrimonium chloride, lauralkonium chloride, cetalkonium chloride, cetrimonium bromide, cetrimonium chloride, cethylamine hydrofluoride, chlorallylmethenamine chloride (Quaternium-15), distearyldimonium chloride (Quaternium-5), dodecyl dimethyl ethylbenzyl ammonium chloride(Quaternium-14), Quaternium-22, Quaternium-26, Quaternium-18 hectorite, dimethylaminoethylchloride hydrochloride, cysteine hydrochloride, diethanolammonium POE (10) oletyl ether phosphate, diethanolammonium POE (3)oleyl ether phosphate, tallow alkonium chloride, dimethyl dioctadecylammoniumbentonite, stearalkonium chloride, domiphen bromide, denatonium benzoate, myristalkonium chloride, laurtrimonium chloride, ethylenediamine dihydrochloride, guanidine hydrochloride, pyridoxine HCl, iofetamine hydrochloride, meglumine hydrochloride, methylbenzethonium chloride, myrtrimonium bromide, oleyltrimonium chloride, polyquaternium-1, procainehydrochloride, cocobetaine, stearalkonium bentonite, stearalkoniumhectonite, stearyl trihydroxyethyl propylenediamine dihydrofluoride, tallowtrimonium chloride, and hexadecyltrimethyl ammonium bromide.

### III. Manufacturing Stabilized, Nanoparticulate Nutritive Compositions

The stable nanoparticulate vitamin compositions are prepared via a method that can include selecting at least one nutritive compound; providing a precursor mixture that includes particles of the at least one nutritive compound, at least one solvent in which the at least one nutritive compound has a solubility of less than 10 mg/ml, and molecules of a stabilizing agent that are dispersible in the at least one solvent and are capable of stably associating with the particles of the at least one nutritive compound; and treating the precursor mixture to produce the stable nanoparticulate nutritive composition, wherein the stable nanoparticulate nutritive composition includes smaller sized nutritive particles having at least a partial coating of stabilizing agent.

In the treating step of the method the nutritive particles are broken down to form a stable nanoparticulate nutritive composition. In practice, the treating step is carried out using, for example, a microfluidizer and/or sonicator.

### A. The Microfluidizer

The primary forces attributed to microfluidization by the microfluidizer for producing either emulsions or dispersions, and for reducing mean particle size include, but are limited to:

shear, involving boundary layers, turbulent flow, acceleration and change in flow direction;

impact, involving collision of the particles processed with solid elements of the microfluidizer, and collision between the particles being processed; and

cavitation, involving an increased change in velocity with a decreased change in pressure, and turbulent flow.

An additional force can be attributed to attrition, i.e., grinding by friction.

A typical microfluidizer consists of an air motor connected to a hydraulic pump which circulates the process fluid. The formulation stream is propelled at high pressures (up to 23,000 psi) through a specially designed interaction chamber which has fixed microchannels that focus the formulation stream and accelerate it to a high velocity. Within the chamber the formulation is subjected to intense shear, impact cavitation, and attrition forces all of which contribute to particle size reduction. After processing, the formulation stream is passed through a heat exchanger coil and can be collected or recirculated through the machine. A microfluidizer is typically used in a continuous processing mode for up to three hours of total processing time. The heat exchanger and interaction chamber are externally cooled with a refrigerated circulating water bath.

### B. Sonication

Sonication acts to break down the nutritive particles in the precursor mixture to smaller particles primarily through inducing high velocity interparticle collisions in the slurry and through the formation of microbubbles that generate violent shockwaves and microjets when the bubbles collapse. The force of interparticle collisions is a function solvent type and the intensity of the sonic energy that is transmitted into the slurry. Bubble collapse and the forces generated therein are a function of the solvent type and the temperature of the solvent during sonication. Briefly stated, the forces generated by bubble collapse are greatest if the vapor pressure of the solvent inside the bubble is minimized. Vapor pressure is a function of solvent type and temperature. As such, it can be advantageous to sonicate at a temperature in a range from about 0° C. to about 40° C., or in a range from about 1° C. to about 30° C., or in a range from about 2° C. to about 20° C., or in a range from about 5° C. to about 10° C.

C. The Process of Making the Stabilized, Nanoparticulate Nutritive Compositions

Regardless of whether microfluidization or sonication or a blend of the two is utilized, the particles of at least one nutritive substance are selected and added to a liquid medium in which the at least one nutritive substance is essentially insoluble to form a premix. The concentration of the nutritive substance in the liquid medium can vary from about 0.1-60% w/w. It is typical, but not essential, that the stabilizing agent be present in the premix. In some embodiments, concentration of the nutritive substance in the liquid medium can range from about 0.1 wt %, 0.2 wt %, 0.5 wt %, 1 wt %, 5 wt %, 10 wt %, 15 wt %, 20 wt %, 25 wt %, 30 wt %, 35 wt %, 40 wt %, 45 wt %, 50 wt %, 55 wt %, or about 60 wt %.

The concentration of the stabilizing agent can vary from about 0.1 to 90%, or from about 1-75%, or from about 20-60%, by weight based on the total combined weight of the nutritive substance and stabilizing agent. In some embodiments, the concentration of the surface modifier can vary from about 0.1%, 0.2%, 0.5%, 1%, 5%, 10%, 15%, 20%, 25%, 30%, 35%, 40%, 45%, 50%, 55%, 60%, 65%, 70%, 75%, 80%, 85%, or 90%, to about 1%, 5%, 10%, 15%, 20%, 25%, 30%, 35%, 40%, 45%, 50%, 55%, 60%, 65%, 70%, or 75%, or to about 20%, 25%, 30%, 35%, 40%, 45%, 50%, 55%, or 60%.

The relative amount of nutritive substance and stabilizing agent can vary widely and the optimal amount of the stabilizing agent can depend, for example, upon the particular nutritive substance and stabilizing agent selected, the critical micelle concentration of the stabilizing agent if it forms micelles, etc.

The premix can be circulated in a microfluidizer continuously first at low pressures, then at maximum capacity having a fluid pressure of from about 3,000 to 30,000 psi until the desired particle size reduction is achieved. The particles should be reduced in size at a temperature which does not significantly degrade the nutritive substance. Processing temperatures in a range from about 0° C. to about 40° C. are typical. Processing temperature in a range from about 1° C. to about 30° C., or from about 2° C. to about 20° C., or from about 5° C. to about 10° C. can also be usefully employed.

There are at least two methods to collect a slurry and re-pass it in a microfluidizer. The “discreet pass” method collects every pass through the microfluidizer until all of the slurry has been passed through before re-introducing it again to the microfluidizer. This guarantees that every substance or particle has “seen” the interaction chamber the same amount of times. The second method recirculates the slurry by collecting it in a receiving tank and allowing the entire mixture to randomly mix and pass through the interaction chamber. We have found that recirculating a slurry is just as effective as the “discreet pass” method, however, maintaining slurry homogeneity in the receiving tank is useful.

In the case of sonication, the precursor mixture is sonicated for a period of time sufficient to break down the nutritive particles in the precursor mixture to nano-scale particles. In one embodiment, the precursor mixture is sonicated for a time between about 5 minutes and about 2 hours. In another embodiment, the precursor mixture is sonicated for a time between about 10 minutes and about 1 hour. In still another embodiment, the precursor mixture is sonicated to for a time between about 15 minutes and about 30 minutes. In some embodiments, the precursor mixture is sonicated for about 5 minutes, 10 minutes, 15 minutes, 20 minutes, 25, minutes, 30 minutes, 35 minutes, 40 minutes, 45 minutes, 50 minutes, 55 minutes, 60 minutes, 90 minutes, or 120 minutes, or about 10 minutes, 15 minutes, 20 minutes, 25, minutes, 30 minutes, 35 minutes, 40 minutes, 45 minutes, 50 minutes, 55 minutes, or 60 minutes, or about 15 minutes, 20 minutes, 25, minutes, or 30 minutes.

As mentioned above, sonication is typically conducted at a low temperature in order to minimize the vapor pressure of the solvent. In this case, it is also advantageous to sonicate at a low temperature to avoid degrading the nutritive substance. As such, it can be advantageous to sonicate at a temperature in a range from about 0° C. to about 40° C., or in a range from about 1° C. to about 30° C., or in a range from about 2° C. to about 20° C., or in a range from about 5° C. to about 10° C.

In one embodiment, the sonicator transmits sonic energy into the precursor mixture in a sequence of pulses. For example, a typical sonication procedure sonication procedure calls for a pulse sequence of 5 seconds on/2 seconds off. If, for example, the sample is sonicated for a total of 21 minutes, 15 minutes are active sonication.

The resulting nanoparticulate nutritive composition is stable and consists of the liquid dispersion medium and the above-described particles. The dispersion of surface modified nutritive nanoparticles can be purified from the solvent and used to supplement the dietary nutritive content in a number ways.

### IV. Food Compositions Containing Stabilized, Nanoparticulate Nutritive Compositions

In one embodiment, a fortified food composition that contains stable nutritive nanoparticles is disclosed. The fortified food composition includes a food medium and stabilized, nanoparticulate nutritive compositions. Stable nutritive nanoparticles can be added to a wide variety of foods, for example, either as a slurry of nanoparticles that includes at least one solvent or as purified nanoparticles.

Food compositions containing stable nutritive nanoparticles exhibit an unexpectedly high degree of bioavailability. The nutritive nanoparticles are readily digested in the body and the nutrients are absorbed with a very small percentage of the nutrients passing through the body undigested and/or unabsorbed. Many so-called “functional foods” are specifically formulated to deliver specific nutrients to the consumer. For example, energy bars (e.g., PowerBars™ or Clif Bars™) are typically formulated to deliver a specific mix of simple and complex carbohydrates, fats, proteins, and amino acids to athletes and other consumers. Incorporation of the nutritive nanoparticles disclosed herein allow for the formulation of foods that provide greater numbers of available nutrients to the consumer.

Moreover, because of their small size, the nutritive nanoparticles exhibit an exceptional mouth feel. For example, many foods that are highly fortified (e.g., energy bars) exhibit a grainy mouth feel that many consumers find objectionable. The nutritive nanoparticles disclosed herein can be used to achieve the same level of nutrient supplementation without imparting a grainy or objectionable mouth feel.

In one embodiment, the fortified food composition includes about 0.001 wt % to about 50 wt % of the stabilized, nanoparticulate nutritive compositions. In another embodiment, the fortified food composition includes about 0.01 wt % to about 40 wt % of the stabilized, nanoparticulate nutritive compositions. In yet another embodiment, the fortified food composition includes about 0.1 wt % to about 30 wt % of the stabilized, nanoparticulate nutritive compositions. In some embodiments, the concentration of the stabilized, nanoparticulate nutritive compositions on the food medium can vary from about 0.001%, 0.01%, 0.1%, 0.2%, 0.5%, 1%, 5%, 10%, 15%, 20%, 25%, 30%, 35%, 40%, 45%, or 50%, to about 0.01%, 0.1%, 0.2%, 0.5%, 1%, 5%, 10%, 15%, 20%, 25%, 30%, 35%, or 40%, or to about 0.1%, 0.2%, 0.5%, 1%, 5%, 10%, 15%, 20%, 25%, or 30%.

The stabilized, nanoparticulate nutritive compositions can be incorporated into a number of foods. Suitable examples of foods include, but are not limited to, pet foods, water-based beverages, processed meat products, processed fish products, gels such as energy gels, jams, pastes, nutrition bars, bakery products, creams, sauces, dairy products, confections, or syrups, and combinations thereof.

The stable nanoparticulate nutritive compositions may be embodied in other specific forms without departing from the spirit or essential characteristics of this disclosure. The described embodiments are to be considered in all respects only as illustrative and not restrictive. All changes that come within the meaning and range of equivalency of the claims are to be embraced within their scope.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A stabilized, nanoparticulate nutritive composition, comprising:
nano-scale particles of at least one nutritive substance, wherein the particles of the at least one nutrient substance have a size in a range from about 1 nm to about 2000 nm; and
molecules of at least one stabilizing agent associated with the nano-scale particles.

2. A stabilized, nanoparticulate nutritive composition as recited in claim 1, wherein the nano-scale particles have a size in a range from about 50 nm to about 1500 nm.

3. A stabilized, nanoparticulate nutritive composition as recited in claim 1, wherein the nano-scale particles have a size in a range from about 100 nm to about 1000 nm.

4. A stabilized, nanoparticulate nutritive composition as recited in claim 1, wherein the nutritive substance includes at least one of a carbohydrate, a protein, a fat, an essential fatty acid, an amino acid, an essential amino acid, a mineral, a water-partitionable vitamin compound, or a lipid-partitionable vitamin compound, and combinations thereof.

5. A stabilized, nanoparticulate nutritive composition as recited in claim 2, wherein the at least one water-partitionable vitamin is chosen from the group consisting of vitamin B₁, vitamin B₂, vitamin B₃, vitamin B₅, vitamin B₆, vitamin B₇, vitamin B₉, vitamin B₁₂, or vitamin C, and combinations thereof.

6. A stabilized, nanoparticulate nutritive composition as recited in claim 2, wherein the at least one lipid-partitionable vitamin is chosen from the group consisting of vitamin A, vitamin D, vitamin E, or vitamin K, and combinations thereof.

7. A stabilized, nanoparticulate nutritive composition as recited in claim 1, wherein the stabilizing agent is configured so as to be crosslinkable.

8. A stabilized, nanoparticulate nutritive composition as recited in claim 1, wherein the stabilizing agent includes at least one of an organic acid, an amino acid, a long-chain amine, a surfactant, an anionic surface stabilizer, a cationic surface stabilizer, a zwitterionic surface stabilizer, or an ionic surface stabilizer, and optionally includes one or more long-chain alcohols.

9. A stabilized, nanoparticulate nutritive composition as recited in claim 5, wherein the organic acid is a fatty acid chosen from the group consisting of butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, uncosanoic acid, docosanoic acid, tricosanoic acid, tetracosanoic acid, undecylenic acid, myristoleic acid, palmitoleic acid, oleic acid, linoleic acid, alpha-linolenic acid, arachidonic acid, eicosapentaenoic acid, erucic acid, docosahexaenoic acid, or metals salts thereof, and combinations thereof.

10. A stabilized, nanoparticulate nutritive composition as recited in claim 5, wherein the amino acid is chosen from the group consisting of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, or valine, and combinations thereof.

11. A stabilized, nanoparticulate nutritive composition as recited in claim 5, wherein the one long-chain amine has chain length of at least 6 carbon atoms.

12. A stabilized, nanoparticulate nutritive composition as recited in claim 5, wherein the surfactant is chosen from the group consisting of octylphenol ethoxylates, phosphonic acids, phosphinic acids, sulfonic acids, polyethylene glycol monoalkyl ethers, and combinations thereof.

13. A stabilized, nanoparticulate nutritive composition as recited in claim 1, wherein the nano-scale particles of the nanoparticulate nutritive composition are substantially stable in water-based and food-based media.

14. A method for preparing a stabilized, nanoparticulate nutritive composition, the method comprising:
treating a precursor mixture to produce nano-scale particles of the at least one nutritive substance, the precursor mixture including;
at least one nutritive substance;
at least one solvent in which the at least one nutritive substance has a solubility of less than 10 mg/ml; and
at least one stabilizing agent; and
wherein the nano-scale particles are stabilized by the stabilizing agent and have a size in a range from about 1 nm to about 2000 nm.

15. A method as recited in claim 12, wherein the nutritive substance includes at least one of a carbohydrate, a protein, a fat, an essential fatty acid, an amino acid, an essential amino acid, a mineral, a water-partitionable vitamin compound, or a lipid-partitionable vitamin compound, and combinations thereof.

16. A method as recited in claim 12, wherein the solvent is chosen from the group consisting of water, aqueous salt solutions, methanol, ethanol, propanol, butanol, glycerol, propylene glycol, propylene glycol ethers, dimethyl formamide, N-methyl pyrrolidone, acetone, diethyl ether, chloroform, benzene, tetrahydrofuran, hexanes, ethyl acetate, methyl methacrylate, toluene, phenyl ethers, vegetable oil, and combinations thereof.

17. A method as recited in claim 12, wherein the stabilizing agent includes at least one crosslinkable agent and/or at least one non-crosslinkable agent, the stabilizing agent being selected from the group consisting of an organic acid, an amino acid, a long-chain amine, a surfactant, an anionic surface stabilizer, a cationic surface stabilizer, a zwitterionic surface stabilizer, or an ionic surface stabilizer, and optionally includes one or more long-chain alcohols, and combinations thereof.

18. A method as recited in claim 12, wherein the treating comprises:
transferring the precursor mixture to a microfluidizer having an interaction chamber capable of producing shear, impact, cavitation, and attrition forces; and
subjecting the precursor mixture to said forces at a temperature not exceeding 40° C. and a fluid pressure of from about 3,000 to about 30,000 psi by passing the precursor mixture through said interaction chamber to obtain stabilized nutritive particles having an effective average particle size of less than about 2000 nm and a coating of stabilizing agent molecules.

19. A method as recited in claim 12, wherein the treating comprises:
sonicating the precursor mixture a temperature not exceeding 40° C., for a time in a range from about 5 minutes to about 2 hours,
wherein the sonicating suspends the at least one nutritive substance in the solvent, allows the stabilizing agent to associate with the at least one nutritive substance, and disrupts or breaks down particles of the at least one nutritive substance into particles having a size in a range from about 1 nm to about 2000 nm.

20. A method as recited in claim 12, further comprising:
adding at least one crosslinking agent so as to crosslink the stabilizing agent.

21. A method as recited in claim 12, further comprising:
separating the stabilized nutritive particles from the solvent.

22. A fortified food composition, comprising:
a food medium; and
a stabilized, nanoparticulate nutritive composition included in the food medium, the stabilized, nanoparticulate nutritive composition including:
nano-scale particles of at least one nutritive substance, wherein the nano-scale particles have a size in a range from about 1 nm to about 2000 nm; and
molecules of at least one stabilizing agent coupled to the nano-scale particles.

23. A fortified food composition as recited in claim 22, wherein the nutritive substance includes at least one of a carbohydrate, a protein, a fat, a fatty acid, an essential fatty acid, an amino acid, an essential amino acid, a mineral, a water-partitionable vitamin compound, or a lipid-partitionable vitamin compound, and combinations thereof.

24. A fortified food composition as recited in claim 22, wherein the stabilizing agent includes at least one of an organic acid, an amino acid, a long-chain amine, a surfactant, an anionic surface stabilizer, a cationic surface stabilizer, a zwitterionic surface stabilizer, or an ionic surface stabilizer, and optionally includes one or more long-chain alcohols.

25. A fortified food composition as recited in claim 22, wherein the food composition includes about 0.001 wt % to about 50 wt % of the stabilized nutritive particles.

26. A fortified food composition as recited in claim 22, wherein the food composition includes about 0.01 wt % to about 40 wt % of the stabilized nutritive particles.

27. A fortified food composition as recited in claim 22, wherein the food composition includes about 0.1 wt % to about 30 wt % of the stabilized nutritive particles.

28. A fortified food composition as recited in claim 22, wherein the food medium is selected from the group consisting of a pet food, water-based beverage, a processed meat product, a processed fish product, a gel, a jam, a paste, a nutrition bar, a bakery product, a cream, a sauce, a dairy product, a confection, or a syrup, and combinations thereof.
